(19) United States
(12) Patent Application Publication
(10) Pub. No.: US 2013/0206803 A1
(43) Pub. Date: Aug. 15, 2013

(54) Smartphone Holder

(71) Applicant: Kun Liu, Redmond, WA (US)

(72) Inventor: Kun Liu, Redmond, WA (US)

(21) Appl. No.: 13/714,339

(22) Filed: Dec. 13, 2012

(30) Foreign Application Priority Data
Feb. 10, 2012 (CN) 201220041727.0

(51) Int. Cl. H04M 1/04

(52) U.S. Cl. CPC H04M 1/04
USPC 224/576; 224/222; 224/197

(57) ABSTRACT

Disclosed is an arm-mountable Smartphone Holder which may provide a convenient way to carry a smartphone. It may include additional user interface components, such as indicator lights and additional buttons for controlling the smartphone, and may provide additional power for longer operations between battery charges.

The Smartphone Holder may include solar panels, speakers, function keys, USB interfaces, SD car interfaces, and a headphone jack, as well as other useful options.

### FIELD

This disclosure relates to a Smartphone Holder.

### BACKGROUND

Smartphones are becoming more and more commonplace, with additional features and functionality being added with each generation. Screens are getting larger, processors are getting faster, and usage is increasing.

### SUMMARY

Disclosed is an arm-mountable Smartphone Holder which may provide a convenient way to carry a smartphone. It may include additional user interface components, such as indicator lights and additional buttons for controlling the smartphone, and may provide additional power for longer operations between battery charges.

The Smartphone Holder may include solar panels, speakers, function keys, USB interfaces, SD car interfaces, and a headphone jack, as well as other useful options.

### BRIEF DESCRIPTION OF THE DRAWINGS

FIG. 1 illustrates a perspective view of a Smartphone Holder with a protective plate in place according to one embodiment.

FIG. 2 illustrates a perspective view of a Smartphone Holder with a fitted case in place according to one embodiment.

FIG. 3 illustrates a perspective view of Smartphone Holder with a Smartphone in place according to one embodiment.

FIG. 4 illustrates a perspective view of Smartphone Holder with a Smartphone in place and covered by a protective plate, according to one embodiment.

FIG. 5 illustrates a Smartphone Holder with a smartphone swiveled vertically on a connector.

FIG. 6 illustrates a Smartphone Holder with a smartphone swiveled on a connector.

### DETAILED DESCRIPTION

A more particular description of certain embodiments of a Smartphone Holder may be had by references to the embodiments shown in the drawings that form a part of this specification, in which like numerals represent like objects.

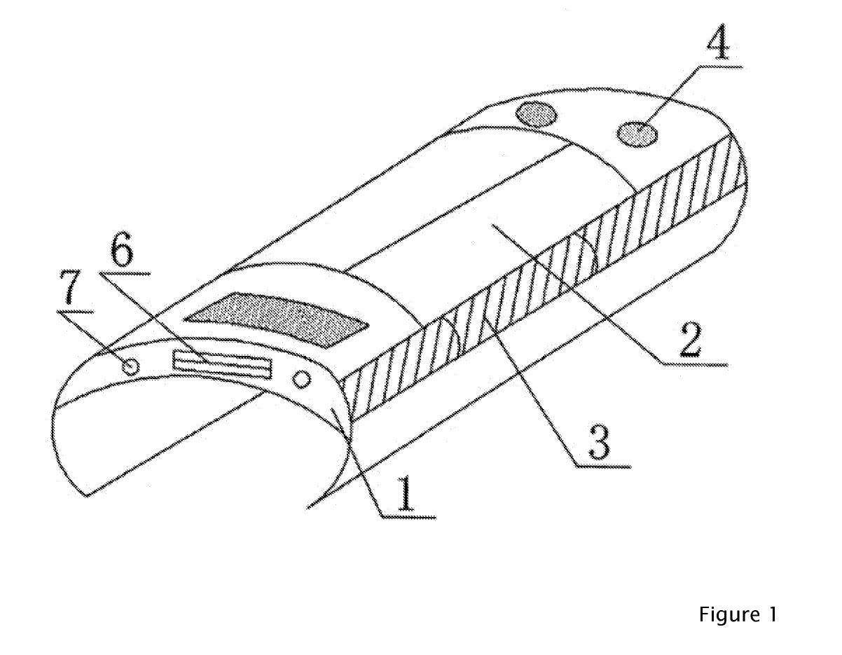

FIG. 1 illustrates a perspective view of a Smartphone Holder with a protective plate in place according to one embodiment. Protective Plate 2 may hold a Smartphone in place, while allowing easy access for insertion and removal. Protective Plate 2 may cover a void for placing a smartphone. Protective Plate 2 may cover the void completely or partially, and there may be two Protective Plates 2; one on each of opposite sides of the void to hold or protect a smartphone. Solar Panel 3 may produce power to operate the Smartphone, charge batteries, or operate other devices on Smartphone Holder 1. Speakers 4 may provide a louder audio signal than built-in speakers on the Smartphone.

A USB Interface 6 may allow charging of the Smartphone batteries, or synchronizing the Smartphone with a desktop computer or other device. A Headphone Jack 7 may be included to allow convenient connection to headphones. An SD card interface, a laser pointer, an LED light, or a soft keyboard may also be provided.

A docking station may be enclosed in the void to provide electrical connections for power and signals to be passed between Smartphone Holder 1 and a smartphone. In another embodiment, a cable may be used for that purpose. In yet another embodiment, wireless signals may be used.

Smartphone Holder 1 may be made to fit on a forearm, and may be made of metal alloys or polymers, or other lightweight material. It may be lined with memory foam or other soft material to improve comfort for a user.

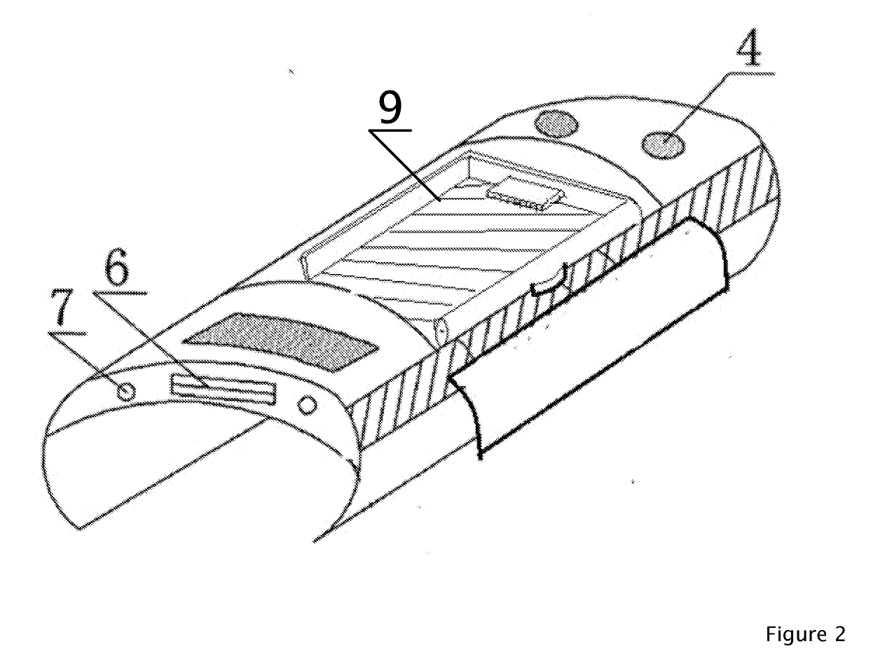

FIG. 2 illustrates a perspective view of a Smartphone Holder with a Fitted Case 9 in place according to one embodiment. Fitted Case 9 may be custom for the type of smartphone, and may provide a secure method of coupling the smartphone to the Smartphone Holder. In another embodiment, Fitted Case 9 may be a universal fit case.

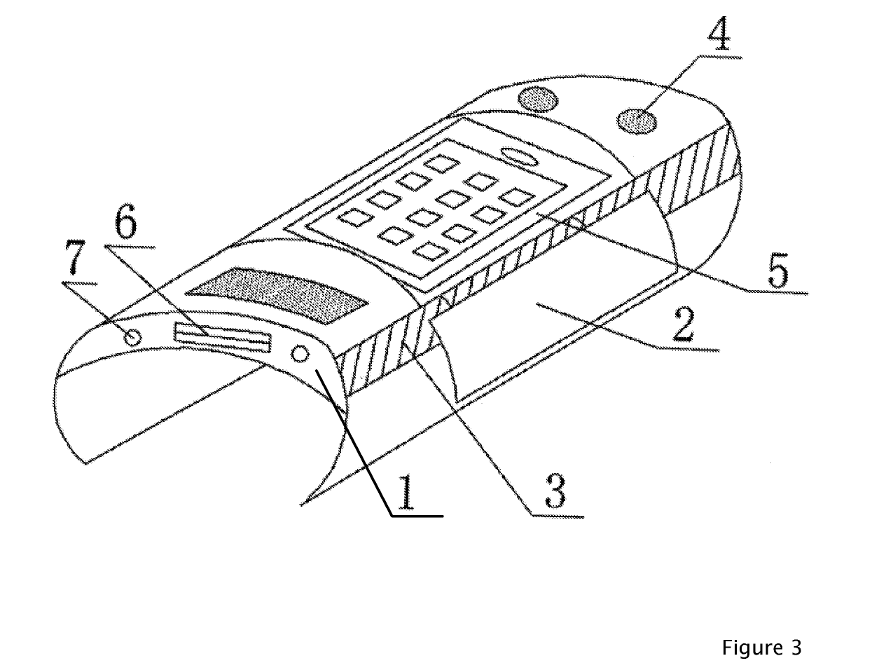

FIG. 3 illustrates a perspective view of Smartphone Holder with a Smartphone in place according to one embodiment. In this figure, Protective Plate 2 is moved, and Smartphone 5 is placed in the Fitted Case 9 on Smartphone Holder 1.

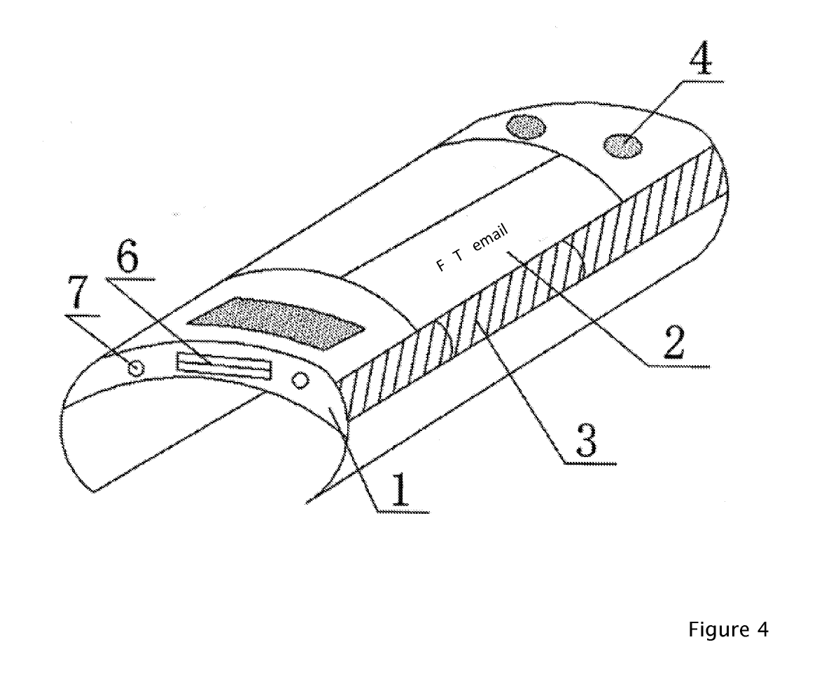

FIG. 4 illustrates a perspective view of Smartphone Holder with a Smartphone in place and covered by Protective Plate 2, according to one embodiment. Protective Plate 2 may have user interface components allowing a user to receive notifications or interact with the smartphone. For example, lights may indicate a status of applications or hardware on the smartphone. In this example, there may be an F indicator to show there is a message on Facebook® a T to indicate new tweets on Twitter®, and an envelope icon or text indicating new email is available. The user interface may be preconfigured in hardware, or may be configurable in software. If implemented in software, the display may change dynamically with events or status changes on the smartphone. The user interface may also include buttons, either hardware switches or soft buttons. In another embodiment, user interface may include a touchpad. In yet another embodiment, other forms of human-machine interfaces may be used.

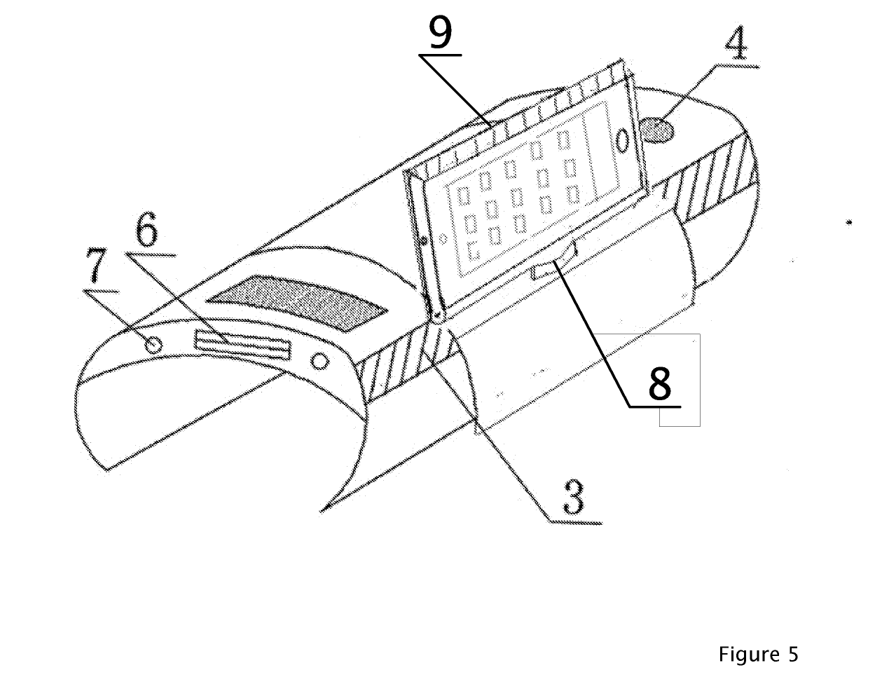

FIG. 5 illustrates a Smartphone Holder with a smartphone swiveled vertically on a Connector 8. Connector 8 may be a ball joint or other flexible connector, joining Fitted Case 9 to the Smartphone Holder. Connector 8 may allow a user to rotate a smartphone to view the screen more easily or to access buttons or other controls on the smartphone.

Fitted Case 9 may be custom for the type of smartphone, and may provide a secure method of coupling the smartphone to the Smartphone Holder. In another embodiment, Fitted Case 9 may be a universal fit case.

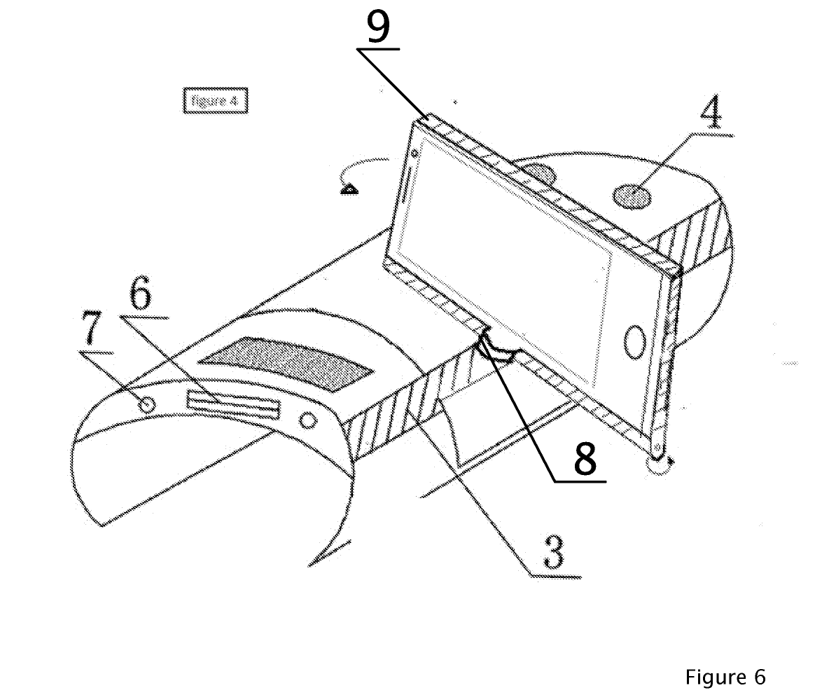

FIG. 6 illustrates a Smartphone Holder with a smartphone swiveled on Connector 8.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention.

1. A smartphone holding device, comprising:
An arm-mountable main casing having a generally open-walled cylindrical shape;
a void in which a smartphone may be inserted;
a fitted case, the fitted case configured to hold the smartphone and coupling electrically with the smartphone; and
a movable protective plate configured to over or expose the void.

2. The smartphone holding device of claim 1, further comprising a device selected from a group comprising a solar cell panel, a speaker, a function key, a USB interface, an SD card interface, a headset interface, a laser pointer, an LED light, and a compact soft keyboard.

3. The smartphone holding device of claim 1, wherein the arm-mountable main casing can bend.

4. The srnartphone holding device of claim 1, wherein the fitted case is coupled to the main casing by a ball-joint connector.

5. The smartphone holding device of claim 1 wherein the main casing is lined with memory foam.
